(19) United States
(12) Patent Application Publication
(10) Pub. No.: US 2025/0040525 A1
(43) Pub. Date: Feb. 6, 2025

(54) Humane Fishhooks and Methods

(71) Applicant: Jonathan Scott Twaddle, Santa Cruz, CA (US)

(72) Inventor: Jonathan Scott Twaddle, Santa Cruz, CA (US)

(21) Appl. No.: 18/365,429

(22) Filed: Aug. 4, 2023

(51) Int. Cl. A01K 83/00; B21F 45/12

(52) U.S. Cl. CPC A01K 83/00; B21F 45/12

(57) ABSTRACT

A barbless fishhook has an eye portion, a shank portion comprising wire of a first diameter proceeding from the eye portion, at least one belly portion proceeding from the shank portion, wherein the wire changes direction by at least 150 degrees, a point portion proceeding from the at least one belly portion to a sharp point, the point portion shaped as a cone with an included angle, providing a taper, and a treated region beginning at a first distance along the wire from the sharp point, proceeding for a length along the wire to a second distance along the wire to at least a beginning of the belly portion. The treated region is treated to provide increased friction between a surface of the wire in the treated region and any matter in contact with the treated region.

### BACKGROUND OF THE INVENTION

### 1. Field of the Invention

The present invention is in the technical field of fishing equipment and pertains more particularly to new barbless hook apparatus and methods.

### 2. Description of Related Art

Fishhooks of both barbed and barbless variety are notoriously well known in the art. It is also well known that most fishhooks commercially available are of the barbed variety, and the use of and regulations regarding use barbless varieties is a development over perhaps the last fifty years.

Many fishermen and women have experienced the difficulties of fishing with barbed hooks. The barb is there to ensure that the fish, once hooked, cannot easily escape by throwing the fishhook or lure. But once the fish is brought in, disengaging the hook from the fish is often a problem. Sometimes a fish has swallowed the hook, and the barb is engaged not in a side of the mouth, but further down the fish's gullet. In that case pulling the hook out is almost certain to kill the fish or injure the fish to the point it will later die. Even if the hook is engaged through a fish's lip, pulling the hook out of the lip can and does cause considerable damage to the fish. Further to these circumstances accidents do happen in which a barbed hook may be lodged in a fisherman's flesh or a bystander's flesh. In this circumstance it is often necessary that the hook be forced further through the flesh and out, so the barb may be clipped off and the hook may then be withdrawn.

Many modern fishermen and women do not fish to keep the catch but to catch and release. If release is the purpose, the damage caused by barbed hooks may be unacceptable. Still, though, just eliminating the barb of the hook may just ensure that far fewer fish may be successfully caught.

What is clearly needed in the art is a fishhook that has no barb of the traditional sort, that causes severe damage, but has one or more elements that tend to keep the hook engaged, once set, but may be easily and painlessly withdrawn.

### BRIEF SUMMARY OF THE INVENTION

In an embodiment of the invention barbless fishhook is provided, comprising an eye portion, a shank portion comprising wire of a first diameter proceeding from the eye portion, at least one belly portion proceeding from the shank portion, wherein the wire changes direction by at least 150 degrees, a point portion proceeding from the at least one belly portion to a sharp point, the point portion shaped as a cone with an included angle, providing a taper, and a treated region beginning at a first distance along the wire from the sharp point, proceeding for a length along the wire to a second distance along the wire to at least a beginning of the belly portion. The taper from the point portion proceeds to at least a beginning of the belly portion, and the treated region is treated to provide a coefficient of friction on a surface of the treated region substantially greater than a coefficient of friction of a surface of the untreated wire of the hook.

In one embodiment the included angle is equal to or greater than ten degrees and equal to or less than twenty degrees. Also, in one embodiment the wire changes direction by from 150 degrees to 210 degrees in the belly portion. In one embodiment the wire changes direction by 180 degrees in the belly portion. And in one embodiment there are three belly portions proceeding from the shank portion, and three point portions, one proceeding from each belly portion, providing a treble hook.

In one embodiment of the invention the treated region is treated by sanding with one of sandpaper or emery paper. Also, in one embodiment the treated region is treated by application of a cutting tool. In one embodiment the treated region is treated by application of a die under pressure. And in one embodiment the treated region is treated by exposure to an acid solution.

In another aspect of the invention a method for making a barbless fishhook is provided, comprising extending a length of wire suitable for a fishhook, treating a fixed length region on the wire to increase a coefficient of friction, forming an eye and a belly portion with the wire having a treated region, and forming a point region having a sharp point and an included angle.

In one embodiment the method comprises making the included angle equal to or greater than ten degrees and equal to or less than twenty degrees. Also, in one embodiment the method comprises bending the wire for the belly portion to change direction by from 150 degrees to 210 degrees. Also, in one embodiment the method comprises bending the wire for the belly portion to change direction by 180 degrees. In one embodiment the method comprises forming three belly portions proceeding from the shank portion, and three point portions, one proceeding from each belly portion, providing a treble hook. And in one embodiment the method comprises forming the treated region by sanding with sandpaper or emery paper.

In one embodiment the method comprises forming the treated region by application of a cutting tool. Also, in one embodiment the method comprises forming the treated region by application of a die under pressure. In one embodiment the method comprises forming the treated region by application of an acid solution. And in one embodiment the method comprises forming the treated region by exposure to an acid solution.

### BRIEF DESCRIPTION OF THE SEVERAL VIEWS OF THE DRAWINGS

FIG. 1A illustrates a prior art barbed hook.

FIG. 1B illustrates an alternative prior art barbed hook.

FIG. 1C illustrates a barbed treble hook in the prior art.

FIG. 2 illustrates a barbless fishhook in an embodiment of the invention.

FIG. 3 illustrates the barbless fishhook of FIG. 2 engaging a material or substance.

FIG. 4A illustrates a hook wire with treated regions in an embodiment of the invention.

FIG. 4B illustrates a process for creating treated regions on hook wire and cutting to length.

FIG. 5A illustrates a geometry for a treated region in an embodiment of the invention.

FIG. 5B illustrates an alternate geometry for a treated region in an embodiment of the invention.

FIG. 5C illustrates another alternate geometry for a treated region in an embodiment of the invention.

FIG. 5D illustrates yet another alternate geometry for a treated region in an embodiment of the invention.

FIG. 5E illustrates yet another alternate geometry for a treated region in an embodiment of the invention.

FIG. 5F illustrates yet another alternate geometry for a treated region in an embodiment of the invention.

FIG. 5G illustrates a geometry in a treated region made to a larger diameter than the hook wire.

FIG. 6 is a flow diagram depicting a process in an embodiment of the invention.

### DETAILED DESCRIPTION OF THE INVENTION

An important object of the present invention is to provide fishhooks that are humane, and cause the least damage to fish, and that also are safer to use and remove if engaged in human or animal flesh by accident. In line with this object fishhooks without barbs are provided in different embodiments.

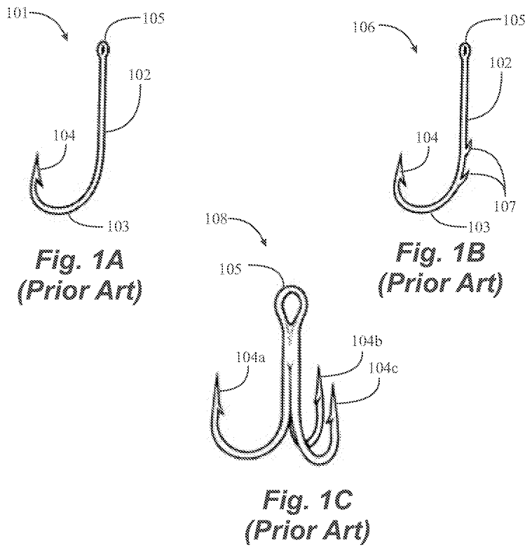

FIG. 1A illustrates a prior art barbed hook 101 made from a single piece of wire, having a shank portion 102, a belly portion 103, a barb 104 at an end of the belly portion, and an eye 105 at an end opposite the barb, for connecting to a fishing line or to a lure. The fishhook may be made from stainless-steel to be rust resistant. All fishhook manufacturers develop and protect their own special recipes when it comes to hook construction, but there are really only two types of metal wire typically used: stainless steel and carbon steel.

FIG. 1B illustrates an alternative prior art barbed hook 106 having the elements of hook 101 and additionally barbs 107 formed on the shank portion.

FIG. 1C illustrates a barbed treble hook 108 in the prior art comprising three belly portions ending in barbs 104a, 104b and 104c, the three belly portions proceeding from a single shank.

The skilled person will understand that fishhooks of this sort may vary considerable in size and weight, as many are produced for use in pursuing small fish like, for example what are called panfish, and many others for game fish and for salt-water game fish. There is in the art a wide variety in size and weight, as well as in specific dimensions and design. The skilled person will be aware as well that fishhooks with barbs are used plentifully on artificial lures of diverse design, both for fresh water and saltwater use.

In embodiments of the instant invention fishhooks are provided that have no barbs and instead have a treatment to the surface of the wire of the hook proximate the pointed end and specific geometry that enhances desired use of the fishhook.

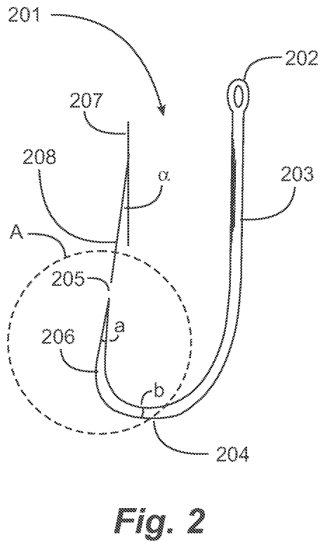

FIG. 2 illustrates a barbless fishhook 201 in an embodiment of the invention. Fishhook 201 has a conventional eye 202, a shank portion 203 proceeding from the eye portion, a belly portion 204 wherein the direction of the wire changes by at least 150 degrees, a sharp point 205 at the end of a conical portion having an included angle not indicated in FIG. 2, and an especially treated region 206 between line “a” and line “b” that is treated to increase friction between the hook material and any material or substance that the fishhook may engage. Region A enclosed in a dashed circle comprises the pointed end of the barbless fishhook, a tapered conical region away from the point, and the especially treated region 206. Region 206 extends away from point 205 to at or near the center of the belly of the hook. In FIG. 2 line 207 is parallel with the axis of the wire of the shank portion. Line 208 is on the axis of the conical region away from the point. The angle α is the variation of the direction of line 207 with line 208. If the angle α is 15 degrees, for example, then the direction of the wire has changed 195 degrees through the belly portion. If the angle α is zero degrees, then the point is directed exactly opposite the axis of the shank portion. In some embodiments the hook may be pointed directly opposite the shank axis, and in some embodiments the hook direction may vary (α) by as much as 30 degrees.

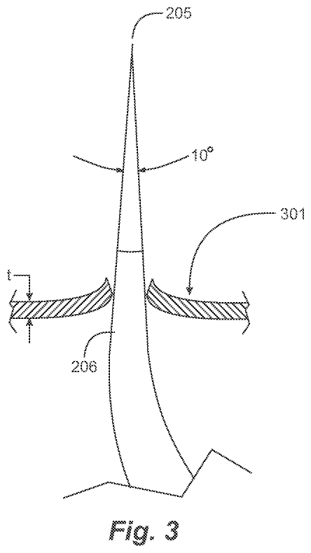

FIG. 3 illustrates the portion of the fishhook of FIG. 2 in dotted circle A, being mainly the pointed end of barbless fishhook 201 engaging a material 301. Material 301 is shown as a membrane having a thickness “t”. The material 301 may be a lip or other membrane of a fish. If a fish's lip the physical nature of the material may be different depending on the species of fish. The lip of a catfish or a carp will be different from that of a bass or a panfish, for example. If the material is flesh rather than membrane, “t” may be a larger dimension, and the physical nature may be softer than if a bony membrane. In the example of FIG. 3 a bony membrane is assumed.

In FIG. 3 the pointed end of the barbless fishhook tapers from sharp point 205 to beyond the beginning at line “a” of the especially treated region 206. The taper in this example is from an included angle of 10 degrees. The included angle and the taper may be different in other embodiments. The included angle may vary between ten degrees and twenty degrees in different embodiments. When the hook is set, that is, when the point enters the membrane only a very small hole is made, and there is little other damage to the membrane. When a barbed hook is set, the barb causes substantial damage to the membrane, such as a tear, and a much larger hole than in the case of the barbless hook. Further, when the barbed hook is pulled out of the membrane the damage is increased.

The pointed end of the barbless hook entering the membrane as illustrated in FIG. 3 does not create a larger hole as the point enters further. Rather, the material of the membrane is stretched outward as shown. If the pointed hook is withdrawn, the opening closes, so when fully withdrawn, the hole may be completely closed.

In operation of the barbless hook according to embodiments of the present invention the pointed end may penetrate to a position that the especially treated region 206 is within the stretched opening as shown in FIG. 3. In many circumstances, because of forces created in playing a hooked fish, the penetration may be to the belly of the hook.

The special treatment in region 206 is a treatment that substantially increases the friction between the hook material and the membrane, such as, for example, a roughening of the surface, which may be accomplished in a number of ways. In one embodiment the surface in region 206 is treated by abrasion with such as sandpaper or emery paper. The surface is roughened and that increases the friction between the hook surface in region 206 and the membrane.

Returning now to FIG. 3, it will be apparent to the skilled person that if the hook is engaged to the position shown with the membrane material pushed aside, the membrane will exert a force inward on the hook in region 206. If the hook is pulled outward the roughened surface in region 206 will engage the edges of the opening and tend to pull the opening further closed, exerting more pressure on treated surface 206 of the hook material. The hook, up to a point in force sufficient to pull the hook out, will tend to stay engaged. In most instances in use this functionality will keep the hook engaged while the fish is played and retrieved.

Once a fish is retrieved the hook may be withdrawn far more easily than if the hook were barbed, and the opening in the membrane will largely close, rather than being torn even more, as with a barbed hook. Further if by accident a barbless hook according to the invention should accidentally be engaged in flesh of a person or a pet, the hook may be rather easily withdrawn with no further damage. The barbless hook according to embodiments of the present invention is thus effective and humane, compared to the use of a barbed hook.

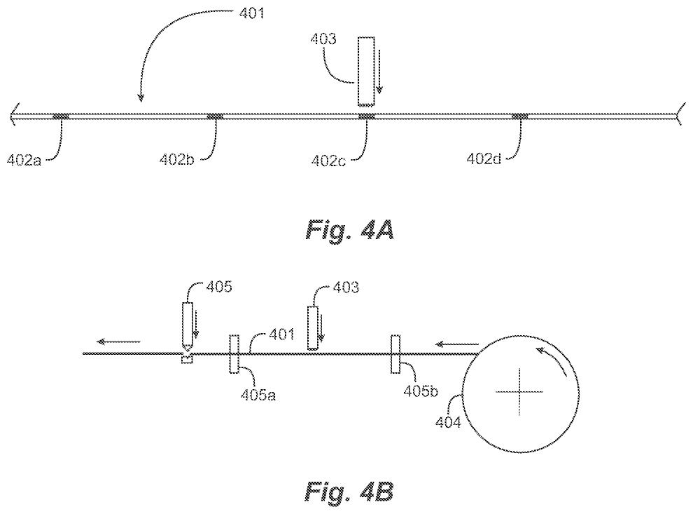

As stated above there are a variety of different ways the treated region 206 may be implemented. By sanding was described above. In one process of making barbless hooks a length of metal wire may be treated in one or more regions while in a straight form. FIG. 4A illustrates a straight length of metal wire 401 with four treated regions 402a through 402d implemented along the length. In one process a tool 403 is provided at one position as shown. The wire may be rotated about its own axis by suitable equipment and the tool advanced to alter the surface of the wire along a length of the region. The wire may then be advanced a predetermined dimension and the process repeated.

In one circumstance the process may be highly automated as indicated in FIG. 4B, which illustrates a coil 404 with wire 401 fed from the coil through guides 405b and 405a in a right to left direction. The wire is rotated about its axis along with the coil and fed intermittently through the guides. The wire is paused at predetermined intervals and tools 403 and 405 are advanced. Tool 403 creates a region 206 on the wire and tool 405 cuts the wire into a length with region 206 positioned such that the cut length may be formed into the barbless hook, including providing the eye, the shape of the hook and the point and taper.

Again, as stated above there are a variety of different ways the treated region 206 may be implemented. Sanding has been described. Cutting tools may be employed in apparatus as described with reference to FIGS. 4A and 4B to mar and roughen the surface of the wire. Heated tools may be used to make indentions or grooves in the roughened regions. In some circumstances roughened surfaces may be accomplished chemically, such as with an acid solution.

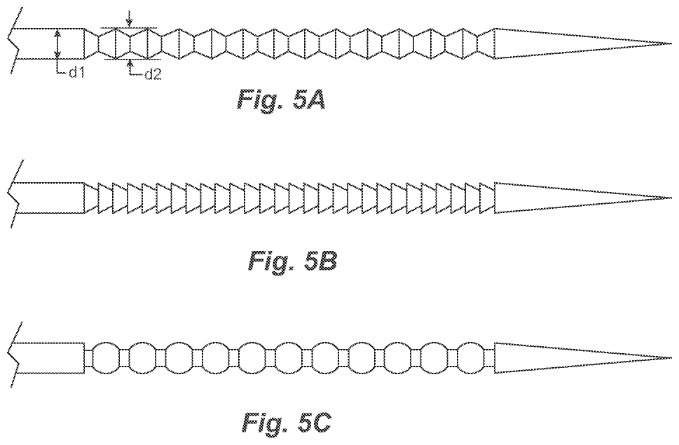

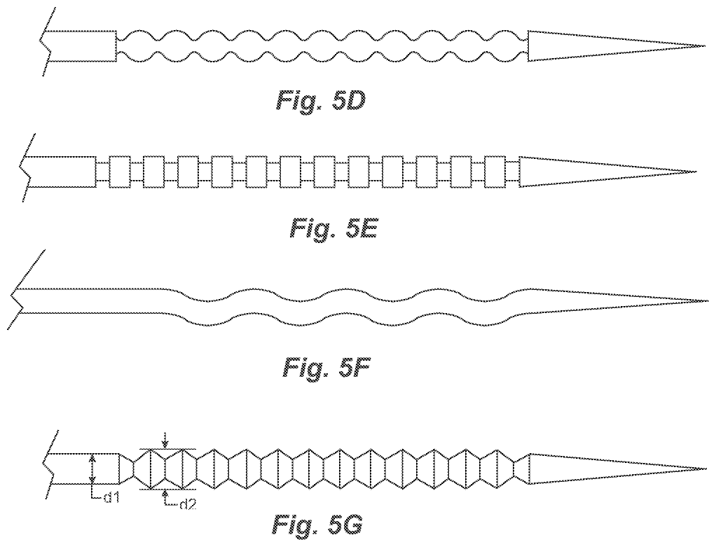

FIGS. 5A, 5B, 5C, 5D, 5E and 5F illustrate example geometrical shapes that may be provided on hook wire by such as rolling or pressing in dies, that may serve as the treated surface needed to substantially increase friction between the hook and material the hook may penetrate. In every example the spacing and depth dimensions may vary.

FIG. 5A shows that the untreated wire has a diameter d1, and the treated region has a diameter d2. In FIG. 5A the diameters are equal. This may be true as well for all of the shapes shown in FIG. 5A through FIG. 5F. FIG. 5G illustrates a circumstance where the diameter d2 of the treated region is larger than the diameter d1 of the untreated wire. This may also be true as well for all of the shapes shown in FIG. 5A through FIG. 5F.

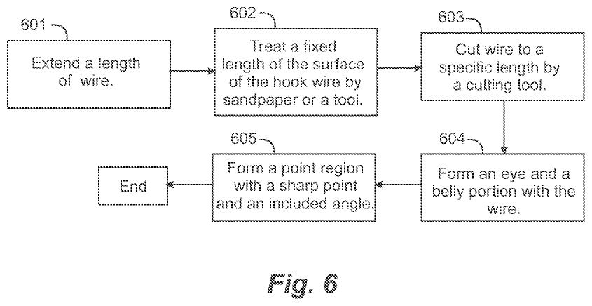

FIG. 6 is a flow diagram illustrating a process for creating a barbless hook in an embodiment of the invention. At step 601 a length of wire suitable for a fishhook is extended. The wire may be of a small diameter for a small fishhook or larger for larger versions. At step 602 a region of a specific length is treated by such as a roughening process to provide a larger coefficient of friction in that region. At step 603 the wire is cut to a specific length including the treated region. As step 604 an eye and a belly region are formed. At step 605 a point region with a sharp point and an included angle is formed on the cut piece. The order of steps may be different in some cases.

It will be clear to the skilled artisan that the several embodiments illustrated and described in this application are exemplary, and not limiting to the scope of the invention. The scope of the invention is limited only by the claims.

1. A barbless fishhook, comprising:
an eye portion;
a shank portion comprising wire of a first diameter proceeding from the eye portion;
at least one belly portion proceeding from the shank portion, wherein the wire changes direction by at least 150 degrees;
a point portion proceeding from the at least one belly portion to a sharp point, the point portion shaped as a cone with an included angle, providing a taper; and
a treated region beginning at a first distance along the wire from the sharp point, proceeding for a length along the wire to a second distance along the wire to at least a beginning of the belly portion;
characterized in that the treated region is treated to provide increased friction between a surface of the wire in the treated region and any matter in contact with the treated region.

2. The barbless fishhook of claim 1 wherein the included angle is equal to or greater than ten degrees and equal to or less than twenty degrees.

3. The barbless fishhook of claim 1 wherein the wire changes direction by from 150 degrees to 210 degrees in the belly portion.

4. The barbless fishhook of claim 3 wherein the wire changes direction by 180 degrees in the belly portion.

5. The barbless fishhook of claim 1 having three belly portions proceeding from the shank portion, and three point portions, one proceeding from each belly portion, providing a treble hook.

6. The barbless fishhook of claim 1 wherein the treated region is treated by sanding with one of sandpaper or emery paper.

7. The barbless fishhook of claim 1 wherein the treated region is formed by application of a cutting tool, creating repeating geometric shapes along the treated region.

8. The barbless fishhook of claim 1 wherein the treated region is formed by application of a die under pressure, creating repeating geometric shapes along the treated region.

9. The barbless fishhook of claim 1 wherein the treated region is formed by exposure to an acid solution.

10. The barbless fishhook of claim 1 wherein the overall diameter of the treated region is greater than the diameter of the untreated wire.

11. A method for making a barbless fishhook, comprising:
extending a length of wire suitable for making a fishhook;
treating a fixed-length region on the wire to increase friction between a surface of the wire in the treated region and any matter in contact with the treated region;
forming an eye and a belly portion with the wire having a treated region; and
forming a point region having a sharp point and an included angle.

12. The method of claim 11 comprising making the included angle equal to or greater than ten degrees and equal to or less than twenty degrees.

13. The method of claim 11 comprising bending the wire for the belly portion to change direction by from 150 degrees to 210 degrees.

14. The method of claim 11 comprising bending the wire for the belly portion to change direction by 180 degrees.

15. The method of claim 11 comprising forming three belly portions proceeding from the shank portion, and three point portions, one proceeding from each belly portion, providing a treble hook.

16. The method of claim 11 comprising forming the treated region by sanding with sandpaper or emery paper.

17. The method of claim 11 comprising forming the treated region by application of a cutting tool. 18. The method of claim 11 comprising forming the treated region by application of a die under pressure.

19. The method of claim 10 comprising forming the treated region by application of an acid solution.

20. The method of claim 11 comprising forming the treated region with an overall diameter greater than wire in the untreated region.
